(19) United States
(12) Patent Application Publication
(10) Pub. No.: US 2024/0261740 A1
(43) Pub. Date: Aug. 8, 2024

(54) Method And Device For Creating A Polysystem For Mixing Seeds And Fertilizers

(71) Applicant: Obschestvo s Ogranichennoi otvetstvennostyu "LILIANI" (OOO "LILIANI"), Rostov-on-Don (RU)

(72) Inventor: Armen Vemirovich Nalbandyan, Rostov-on-Don (RU)

(21) Appl. No.: 18/564,059

(22) PCT Filed: Nov. 19, 2022
(86) PCT No.: PCT/RU2022/000167

§ 371 Date: Nov. 24, 2023

(30) Foreign Application Priority Data
May 24, 2021 (RU) 2021114617

(51) Int. Cl. B01F 23/64; A01C 7/06; B01F 33/502; B01F 35/80; B01F 101/32; B65G 33/08

(52) U.S. Cl. CPC B01F 23/64; B01F 33/502; B01F 35/892; A01C 7/06; B01F 2101/32; B65G 33/08

(57) ABSTRACT

The invention refers to field of preparation to agriculture works, more specifically to the helping operations, before seeding and fertilizing the soil.

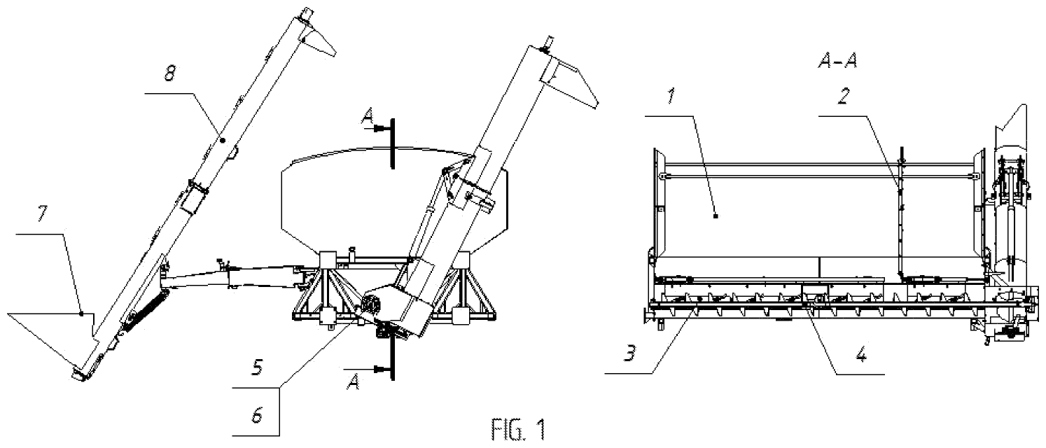

The method of preparation to agriculture works includes in it:
placement of a few types of seeds and/or fertilizes in mobile capacity, which have at least one separating wall, which separates this capacity to at least two capacities for separating storage of content, moving of mobile capacity to the agriculture work area moving the content of at least two aforementioned capacities with the help of apertures with adjustable closing in to movement device that working, located in lower part of aforementioned capacities, moving of mobile capacities content in to destination point and mixing of the content while moving.

Declarant invention provides automation of process in mixing process of seeds and/or fertilizes, reducing time, needed for preparation to sowing and/or fertilizing the soil, increasing functional abilities while preparing to agriculture works.

### TECHNICAL FIELD

The invention refers to field of preparation to agriculture works, more specifically to the helping operations, before seeding and fertilizing the soil.

### Preceding Level of Technology

Nowadays known methods of preparation to agriculture works, in which before sowing or fertilizing soil determine type of necessary for soil fertilize or which seeds necessary for sowing, moving this fertilizes or seeds to the agriculture work area, and then proceed to fertilizing or sowing the seeds.

Such methods useful, but have some disadvantages. Most efficient fertilizing the soils occurs while using mixtures seeds from different fertilizes. While sowing seeds emerging necessity also fertilize the soil. Mixing seeds and/or fertilizes before sowing and/or fertilizing the soil leads to extra work spending and lost time.

The task set by the developer of method and device of preparation to agriculture works consist in developing of method and device, which can afford automized mixing of different types of different seeds and fertilizes, reducing time, needed for preparation to sowing and/or fertilizing the soil.

Technical result of declared method and device of preparation to agriculture works, is automation of mixing process of seeds and/or fertilizes, reducing time, needed for preparation to sowing and/or fertilizing the soil, increasing functional abilities while preparing to agriculture works.

### DISCLOSURE OF INVENTION

The essence of the method of preparation to agriculture works consist in next.

At first in mobile capacity which have at least one separating wall, which separates capacity to at least two capacities, inserting seeds different from each other plants in way, that every aforementioned capacity contains one certain type of seeds, either inserting different from each other fertilizers in a way, that every aforementioned capacity contains one certain type of fertilizers, or inserting seeds and fertilizers in a way that seeds and fertilizers remains in different aforementioned capacities.

Then moving aforementioned mobile capacity with at least one separating wall to the agriculture work area.

Afterwards with the help of apertures with adjustable closing, which located in lower part of every aforementioned capacities, adjustable backlash created by aforementioned apertures with adjustable closing, gradually moving content simultaneously at least two aforementioned capacities in movement device that working, which located under aforementioned apertures with adjustable closing.

Farther with at least one movement device, moving content at least two mobile capacities in destination point, while mixing in process of movement this content in necessary proportions, prescribed aforementioned adjustable backlash.

As movement device can be used auger. Due to type of seeds and/or fertilizes can adjust setting of adjustable backlashes, created by aforementioned apertures with adjustable closing in a way, that every backlash allowed to move certain volume of seeds or fertilizes in time unit in working movement device.

The essence of the method of preparation to agriculture works according to second variant of perfomance consist in next

At first in at least two mobile capacities, inserting seeds different from each other plants in way, that every aforementioned capacity contains one certain type of seeds, either inserting different from each other fertilizers in a way, that every aforementioned capacity contains one certain type of fertilizers, or inserting seeds and fertilizers in a way that seeds and fertilizers remains in different aforementioned capacities,
then moving aforementioned mobile capacities to the agriculture work area,

Afterwards with the help of apertures with adjustable closing, which located in lower part of every aforementioned capacities, controlling backlash created by aforementioned apertures with adjustable closing, gradually moving content simultaneously at least two aforementioned capacities in movement device that working, and located under aforementioned apertures with adjustable closing,

Farther with at least one movement device, moving content of at least two mobile capacities in destination point, while mixing in process of movement this content in necessary proportions, prescribed aforementioned adjustable backlash.

The device of preparation to agriculture works consist from:
capacity which have at least one separating wall, which separates aforementioned capacity to at least two capacities,
apertures with adjustable closing and ability to control backlash, created by this apertures, while aforementioned apertures located in lower part of every aforementioned at least two capacities,
at least one movement device, located under aforementioned apertures with adjustable closing,
at least one motor, or motor-reducer, or power take-off shaft acquisition,
torque transmission mechanism,
control systems.

The device of preparation to agriculture works can have dosing hopper, and at least one movement device, which moving seeds or fertilizers from dosing hopper to at least one of aforementioned capacities, created by aforementioned separating wall.

### EXAMPLE OF A SPECIFIC APPLICATION OF THE INVENTION

Declared method of preparation to agriculture works consist in next. For realization of the method at first in mobile capacity which have at least one separated wall, which separates it on at least two capacities, inserting seeds different from each other plants in way, that every single aforementioned capacity contents one specific type of seeds, either inserting different from each other fertilizers in way, that every single aforementioned capacity contents one specific type of fertilize, or inserting seeds and fertilizes in a way, that seeds and fertilizes were in different aforementioned capacities.

As a mobile capacity it is necessary to understand the capacity, which adapted to quick movement in space, such movement in space can be provided by wheels, located on outer side in lower part of capacity and ability to fix capacity to trucks or capacity can have it's own motor for movement in space, As example of mobile capacity can be different car trailer or trucks. Inside of such mobile capacity for invention performance should be at least one separated wall which separates capacity for at least two capacities that will be an ability to locate in this capacities different seeds and/or fertilizers without mixing them inside this capacities. Such separated walls can be a lot. The more separated walls, then more accordingly created inside capacities, then more different seeds and/or fertilizers can be used while using described invention. Beside at least two capacities from common amount of capacities on which separates, separating wall should contain different content. For example one capacity can hold seeds of one variety of wheat while second capacity can hold seeds of another variety of wheat, or one capacity can hold nitrogen fertilizers, while second capacity can hold phosphorus fertilizers. Or for example one capacity holding seeds and second fertilizers. Beside a few capacities can hold the same content, if at least one of capacities have another content.

After that, when in aforementioned capacities, which are part of mobile capacity inserts seeds or fertilizes, aforementioned mobile capacity with at least one separating wall, moving to agriculture work area. For example if mobile capacity is a dosing hopper, then it can drive to field laded by various content, or moving on field if necessary.

Afterwards with the help of apertures with adjustable closing, which located in lower part of every aforementioned capacities, adjustable backlash created by aforementioned apertures with adjustable closing, gradually moving content simultaneously at least two aforementioned capacities in working movement device, which located under aforementioned apertures with adjustable closing. Apertures with adjustable closing in lower part of every aforementioned capacities disposing with the aim to move capacities content in movement device that in working process under gravity. Beside as device, which controlling apertures closing can be used curtain or any other known from technic level. As movement device can be used for example auger, conveyer or any other known movement device.

Farther with at least one movement device, moving content of at least two mobile capacities in destination point, while mixing in process of movement this content in necessary proportions, prescribed aforementioned adjustable backlash. For example, if necessary to sow seeds of wheat with using phosphorus fertilizes, for this opening capacity's apertures, which contain wheat seeds and capacity which contain phosphorus fertilizes, besides as necessary controlling size of backlash which stayed by device, adjusting apertures closing for controlling proportions of mixing. Seeds and fertilizers under gravity moving, for example in in auger that working, which mixing seeds with fertilizers in process of mixing. Mixed content of capacities can be moved, for example, in seeder for farther sowing of seeds.

According to the type of seeds and/or fertilizers can also doing adjust of adjustable backlashes, created by aforementioned apertures with adjustable closing in a way, that every backlash allowed to move certain type of seeds and fertilizes in time unit in moving device that working.

Because different content inserted in capacities have different properties, then for increasing accuracy of proportions in mixing it is necessary to consider properties of certain content and adjust size of backlash which stayed by closing device.

According to second of performance method of preparation to agriculture works consist in next. At first in at least two mobile capacities, inserting seeds different from each other plants in way, that every aforementioned capacity contains one certain type of seeds, either inserting different from each other fertilizers in a way, that every aforementioned capacity contains one certain type of fertilizers, or inserting seeds and fertilizers in a way that seeds and fertilizers remains in different aforementioned capacities, then moving aforementioned mobile capacities to the agriculture work area, afterwards with the help of apertures with adjustable closing, which located in lower part of every aforementioned capacities, controlling backlash created by aforementioned apertures with adjustable closing, gradually moving content simultaneously at least two aforementioned capacities in movement device that working, and located under aforementioned apertures with adjustable closing, farther with at least one movement device, moving content of at least two mobile capacities in destination point, while mixing in process of movement this content in necessary proportions, prescribed aforementioned adjustable backlash.

The second variant of performance wherein in addition, from first variant of perfomance that in capacities in which inserting seeds and/or fertilizers are not the part of one capacity. But under this capacities also placed movement device, which mixing content which comes in it from capacities.

The device of preparation to agriculture works consist of: capacity which have at least one separating wall, which separates capacity to at least two capacities, apertures with adjustable closing and ability to adjust backlash created by this backlashes, while this aforementioned apertures located in lower part of every aforementioned at least two capacities, at least one movement device located under aforementioned apertures with adjustable closing, at least one motor, or motor-reducer, or power take-off shaft acquisition, torque transmission mechanism, control systems.

To provide movement in described device can be used any devices which create torque moment or using torque moment, created by other devices. Such devices can be motor, or motor-reducer, or power take-off shaft acquisition, and etc.

For specialist from this sphere of technic it is also obvious that for transferring drive torque it is necessary to use torque transmission mechanism, for example, such torque transmission mechanism can be belt coupling, gearing, screw gears, friction gears etc. Such mechanisms widely known from technic level and there is no reason to describe them closely.

The device of preparation to agriculture works can hold dosing hopper and at least one movement device, which moving seeds and fertilizers from dosing hopper into at least one of aforementioned capacities, created by aforementioned separated wall. Such decision used with purpose to automized the process of lading the seeds and fertilizers in capacity.

Described invention also envisaging placing inside of one capacity seeds with different type of humidity. For example in one capacity can be inserts overdried seeds and seeds with excess humidity. In that case in process of seeds storage in that capacity happening transition of humidity from seeds with excess humidity, to overdried seeds and while following to certain proportions can be reached humidity index, envisaged by government standard.

Examples, described in description can't limiting invention and work for common understanding of invention.

### INDUSTRIAL APPLICABILITY

Due to moving capacities content performance and mixing of this content simultaneously, occurs time economy which necessary for preparation to sowing and/or fertilizing the soil. Increasing functional abilities reaching by ability to use one vehicle unit, for example dosing hopper for getting a lot of different mixture from seeds and fertilizers which located inside of this hopper. Invention also allow to prepare by one vehicle unit different types of mixture for nearest fields which needed different fertilizers and seeds without necessity to return to the storage for seeds and fertilizers.

1. The method of preparation to agriculture works, in which
at first in mobile capacity which have at least one separating wall, which separates capacity to at least two capacities, inserting seeds different from each other plants in way, that every aforementioned capacity contains one certain type of seeds, either inserting different from each other fertilizers in a way, that every aforementioned capacity contains one certain type of fertilizers, or inserting seeds and fertilizers in a way that seeds and fertilizers remains in different aforementioned capacities,
then moving aforementioned mobile capacity with at least one separating wall to the agriculture work area,
afterwards with the help of apertures with adjustable closing, which located in lower part of every aforementioned capacities, controlling backlash created by aforementioned apertures with adjustable closing, gradually moving content simultaneously at least two aforementioned capacities in movement device that working, and located under aforementioned apertures with adjustable closing,
farther with at least one movement device, moving content at least two mobile capacities in destination point, while mixing in process of movement this content in necessary proportions, prescribed aforementioned adjustable backlash.

2. The method of preparation to agriculture works based on claim 1, wherein in addition, that according to types of seeds and/or fertilizers adjusting settings of backlashes, created by aforementioned apertures with adjustable closing in a way, that every single backlash allowed to move certain volume of seeds or fertilizers in time unit in movement device that working.

3. The device of preparation to agriculture works consist from:
capacity which have at least one separating wall, which separates aforementioned capacity to at least two capacities,
apertures with adjustable closing and ability to control backlash, created by this apertures, while aforementioned apertures located in lower part of every aforementioned at least two capacities,
at least one movement device, located under aforementioned apertures with adjustable closing,
at least one motor, or motor-reducer, or power take-off shaft acquisition,
torque transmission mechanism,
control systems

4. The device of preparation to agriculture works based on claim 3, wherein in addition, that device additionally have:
dosing hopper,
at least one movement device, which moving seeds or fertilizers from dosing hopper to at least one of aforementioned capacities, created by aforementioned separating wall.
